(19) United States
(12) Patent Application Publication
(10) Pub. No.: US 2025/0004803 A1
(43) Pub. Date: Jan. 2, 2025

(54) CONTINUOUS STRATEGIC ALIGNMENT IN CLOUD-BASED ENVIRONMENTS

(71) Applicant: International Business Machines Corporation, Armonk, NY (US)

(72) Inventor: MAINAK KUMAR MANDAL, KOLKATA (IN)

(73) Assignee: International Business Machines Corporation, Armonk, NY (US)

(21) Appl. No.: 18/214,674

(22) Filed: Jun. 27, 2023

(51) Int. Cl. G06F 9/455

(52) U.S. Cl. CPC G06F 9/45558; G06F 2009/4557

(57) ABSTRACT

An embodiment predicts a plurality of strategies associated with a cloud workload. The embodiment presents the predicted plurality of strategies to a user for selection of a strategy. The embodiment predicts a first technology for the cloud workload having a first technology strategic potential value based on the selected strategy. The embodiment predicts a first deployment for the cloud workload having a first deployment strategic potential value based on the selected strategy. The embodiment identifies a second technology for the cloud workload having a second technology strategic potential value based on the selected strategy. The embodiment identifies a second deployment for the cloud workload having a second deployment strategic potential value based on the selected strategy. The embodiment transmits a strategic alert.

### BACKGROUND

The present invention relates generally to cloud computing. More particularly, the present invention relates to a method, system, and computer program for continuous strategic alignment in cloud-based environments.

Cloud platforms like IBM Cloud, Amazon Web Services (AWS), and Microsoft Azure have become critical assets for businesses of all sizes. They provide a Platform as a Service (PaaS) model that allows users to develop, run, and manage applications without the complexity of building and maintaining the infrastructure typically associated with developing and launching an app. PaaS providers host runtime, middleware, operating system, virtualization, servers, storage, and networking for users. The cloud console provided by these services allows users to manage these resources and deployments. These consoles show the state of the infrastructure, allow for the configuration of resources, and give insights into the usage and performance of the applications running on them.

### SUMMARY

The illustrative embodiments provide for continuous strategic alignment in cloud-based environments.

An embodiment includes predicting, using a workload strategy predictor, a plurality of strategies associated with a cloud workload. The process of predicting a plurality of strategies associated with a cloud workload using a workload strategy predictor provides the advantage of employing data-driven analytics. This can lead to superior performance, cost efficiency, and other beneficial outcomes by suggesting the most suitable strategies for managing cloud workloads.

The embodiment also includes presenting the predicted plurality of strategies to a user for selection of a strategy. Presenting these predicted strategies to a user for selection allows for a more customized and adaptable cloud workload management, as it accommodates the specific needs and preferences of the user or organization.

The embodiment also includes predicting, using a strategic technology predictor, a first technology for the cloud workload having a first technology strategic potential value based on the selected strategy. The use of a strategic technology predictor to predict the best technology for the cloud workload based on the selected strategy aligns the chosen technology with the strategic goals, ensuring optimal usage of technological resources.

The embodiment also includes predicting, using a strategic deployment predictor, a first deployment for the cloud workload having a first deployment strategic potential value based on the selected strategy. Using a strategic deployment predictor to predict the first deployment for the cloud workload based on the selected strategy improves the efficiency of the cloud workload operation by identifying an optimal deployment pattern.

The embodiment also includes executing the strategic technology predictor to identify a second technology for the cloud workload having a second technology strategic potential value based on the selected strategy, the second technology strategic potential value of the second technology indicating a greater technology strategic potential than the first technology strategic potential value of the first technology. The embodiment also includes executing the strategic deployment predictor to identify a second deployment for the cloud workload having a second deployment strategic potential value based on the selected strategy, the second deployment strategic potential value of the second deployment indicating a greater deployment strategic potential than the first deployment strategic potential value of the first deployment. Continuously reassessing the chosen technology and deployment for the cloud workload using the strategic technology predictor and the strategic deployment predictor, respectively, ensures that the most optimal choices remain in use, accommodating changes in technology availability, the workload, or the selected strategy.

The embodiment also includes transmitting, responsive to the executing the strategic technology predictor and the executing the strategic deployment predictor, a strategic alert. Transmitting a strategic alert to relevant stakeholders following the execution of the strategic technology and deployment predictors enables efficient decision-making and a swift response to changing circumstances.

The overall technical effect of this embodiment integrates workload strategy predictors, strategic technology predictors, and strategic deployment predictors into a dynamically adaptable cloud workload management system. By enabling continuous monitoring and alerting, the system ensures maximum alignment between cloud workload operations and strategic objectives. It also optimizes the use of technologies and deployment patterns, facilitating agile responses to changes. This results in enhanced operational efficiency, cost-effectiveness, performance, and strategic alignment in the management of cloud workloads. Other embodiments of this aspect include corresponding computer systems, apparatus, and computer programs recorded on one or more computer storage devices, each configured to perform the actions of the embodiment.

An embodiment includes where the strategic technology predictor includes a machine learning model configured to identify a plurality of technologies based on the cloud workload and the selected strategy. An embodiment also includes where the strategic deployment predictor includes a machine learning model configured to identify a plurality of deployments based on the cloud workload and the selected strategy. This presents a distinct technical advantage because machine learning models allow for automatic learning and improvement from experience without being explicitly programmed. These models are designed to identify a plurality of technologies and deployments, respectively, based on the cloud workload and the selected strategy. This capacity for automated identification enhances the speed and accuracy of decision-making processes, leading to more efficient workload management.

An embodiment includes generating a strategic report depicting an overview of the cloud workload, the selected strategy, the first technology, and the first deployment. This report creates a clear, concise summary of key strategic decisions, fostering transparency and enabling informed decision-making.

An embodiment includes where the strategic alert includes one of an application notification, an email message, and a mobile phone message. The versatility of the alerting system allows for greater accessibility, ensuring timely delivery of crucial information to stakeholders across various platforms.

An embodiment includes storing a strategic decision having the cloud workload, the selected strategy, the first technology, and the first deployment. The advantage of this storage capability lies in its ability to record and reference key strategic decisions, facilitating continuous learning and improving future strategic alignment.

An embodiment includes computing strategic potential values based on a strategic need. An embodiment includes where a technology strategic potential value is based at least in part on technology capability and technology cost. An embodiment also includes where a deployment strategic potential value is based at least in part on deployment capability and deployment cost. A technology capability and/or a deployment capability may be based on a strategic need. These considerations bring a balanced perspective, taking into account both the performance and the financial implications of technology and deployment choices, which results in more strategically-aligned and economically-efficient decisions.

An embodiment includes executing the strategic technology predictor and executing the strategic deployment predictor on a pre-determined schedule. This ensures that the cloud workload management process is systematic, consistent, and adaptive to dynamic changes in cloud technology and deployment options. Given the rapid pace of technological advancements and changes in workload or strategic direction, consistent and scheduled execution of these predictors can provide a competitive edge. The schedule helps to avoid gaps in monitoring or unnecessary redundancy and ensures that the analysis is regularly updated. This regularity can lead to early detection of better-suited technologies and deployments that may emerge over time, thus facilitating timely updates in the cloud workload's strategy. Furthermore, it reduces the chances of operating under outdated strategies or technologies, thereby improving overall efficiency and effectiveness of cloud workload management.

An embodiment includes presenting a strategic cloud view including a percentage of cloud workloads in alignment with the selected strategy. This visualization offers a clear and intuitive understanding of the strategic alignment of the cloud workloads. By quantifying and visualizing the alignment, stakeholders can swiftly gauge the performance of their strategic decisions and easily identify any discrepancies or misalignments. This promotes a more proactive management approach, as users can react promptly to optimize the alignment whenever it deviates from the desired state. Furthermore, such a representation can also facilitate better communication among diverse stakeholders, making it easier for them to comprehend the current status and any required strategic shifts. Hence, this embodiment significantly enhances the agility, transparency, and effectiveness of strategic decision-making in cloud workload management.

In its totality, the embodiments incorporate machine learning models, diverse alert systems, and strategically balanced decision-making, creating a comprehensive, agile, and adaptive cloud workload management system. The implementation of these described techniques may include hardware, a method or process, or a computer tangible medium. The overall technical effect of this embodiment leads to improved operational efficiency, cost-effectiveness, and strategic alignment in managing cloud workloads.

An embodiment includes the strategic technology predictor and the strategic deployment predictor both comprising machine learning models configured to identify a plurality of technologies and deployments respectively, based on the cloud workload and the selected strategy. Additionally, it includes the determination of technology and deployment strategic potential values, which are based at least in part on technology and deployment capabilities and costs. This may aid to meet strategic needs of an organization.

This combination represents a robust and highly adaptive approach to cloud workload management, utilizing machine learning to enhance prediction accuracy and efficiency. With the ability to identify multiple technologies and deployments based on cloud workload and strategy, the system ensures a broad range of options are considered, leading to optimized decision-making. The incorporation of capability and cost factors in calculating strategic potential values enables a balanced and comprehensive evaluation of options, which in turn contributes to more effective and cost-efficient cloud workload management.

For example, suppose a company is attempting to optimize its cloud workload management. It would input its cloud workload and preferred strategy into the system, which then uses the machine learning models of the strategic technology predictor and the strategic deployment predictor to identify a range of suitable technologies and deployments. The system would evaluate the strategic potential of each option based on its capability and cost, helping the company to select the most strategically-aligned and cost-effective technology and deployment for its specific cloud workload.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment.

FIG. 2 depicts a block diagram of an example software integration process in accordance with an illustrative embodiment.

FIG. 3 depicts a block diagram of an example strategic cloud management system in accordance with an illustrative embodiment.

FIG. 4 depicts a block diagram of an example strategic cloud manager in accordance with an illustrative embodiment.

FIG. 5 depicts a block diagram of an example data discovery and classification layer in accordance with an illustrative embodiment.

FIG. 6 depicts a block diagram of an example data learning and decision-making layer in accordance with an illustrative embodiment.

FIG. 7 depicts a block diagram of an example strategic operation center layer in accordance with an illustrative embodiment.

FIG. 8 depicts a block diagram of an example strategic cloud layer in accordance with an illustrative embodiment.

FIG. 9 depicts a block diagram of an example strategic alerts and recommendations in accordance with an illustrative embodiment.

FIG. 10 depicts a block diagram of an example process for strategic cloud management in accordance with an illustrative embodiment.

FIG. 11 depicts a block diagram of an example process for strategic cloud management in accordance with an illustrative embodiment.

### DETAILED DESCRIPTION

In today's digital age, cloud computing platforms such as IBM Cloud, Amazon Web Services (AWS), and Microsoft Azure have established themselves as fundamental enablers for businesses. They provide Platform as a Service (PaaS), a critical tool that allows organizations to streamline their operations, optimize resources, and propel growth. Despite their innovative capabilities, these platforms fall short in one fundamental aspect—the lack of features that allow organizations to directly map and visualize their cloud workloads in line with their strategic objectives. This indicates a disconnect between the cloud proposition and the strategic imperatives guiding a given workload. Current cloud consoles provide a clear picture of what the workloads are and how they're deployed, but they fail to explain why they exist and how they align with an organization's strategic “Why.”

A series of disconnects underscores this issue. Current cloud consoles do not offer options to associate workloads with an organization's overarching strategy, nor do they link workloads to core products or services. Decision-makers, including CEOs, CIOs, and product owners, lack visibility into how each workload contributes to the overall value of the organization by promoting differentiation or cost leadership for core or supporting products or services. There is no step-by-step approach to define and deploy workloads based on specific business strategies, nor do these consoles reflect how strategic changes like cost versus differentiation are being fulfilled by a particular workload over time.

Moreover, current cloud consoles offer no feature to ascertain if a given workload has lost its strategic relevance due to changes in industry trends, technology advancements, or shifts in organizational strategy. Equally, there is no provision to check if a workload remains relevant against the evolving nature of the organization's strategy. Proactive alerts to escalate issues with current workload technology, based on the latest technology advancements and strategic alignment of the workload, are also absent. Competitive benchmarking capabilities for assessing the relative performance of workloads in terms of related technology are also not present. Finally, these consoles fail to provide automated proactive suggestions to harmonize strategic changes within the organization with its cloud workloads, creating a significant gap in effective strategic execution.

The present disclosure addresses the deficiencies described above by providing a process (as well as a system, method, machine-readable medium, etc.) that facilitates direct mapping and visualization of cloud workloads in alignment with an organization's strategic objectives. This may include connecting workloads to the organization's overarching strategy and core products or services, tracking how each workload contributes to the overall value proposition, and offering a step-by-step guide to defining and deploying workloads based on specific business strategies. It may also encompass features to monitor the strategic relevance of workloads over time, given changes in industry trends, technology advancements, or shifts in organizational strategy. Proactive alerts regarding potential issues with workload technologies, competitive benchmarking tools, and automated suggestions to synchronize strategic changes with cloud workloads may also be components of this innovative approach.

The illustrative embodiments provide for strategic alignment in cloud-based environments. “Strategic alignment,” as used herein, may refer to the process of ensuring all elements of a business-including resources, operations, and actions—are working together to support and achieve the organization's defined strategy and goals. It may involve synchronizing the business strategy with its technology, processes, and people, enabling them to collectively move towards the organization's objectives. “Cloud-based environment,” as used herein, may refer to the virtual infrastructure provided over the internet by cloud service providers. This may encompass storage, servers, databases, networking, software, and analytics services that are delivered via the internet (the cloud). It may allow businesses to operate and access their data and applications anytime, anywhere, often promoting cost savings, scalability, and business continuity.

Illustrative embodiments include providing a strategic cloud analysis. “Strategic cloud analysis,” as used herein, may refer to the process of examining, assessing, and/or interpreting cloud-based workloads and operations within an organization in alignment with its strategic objectives. This process may involve evaluating technology choices, resource allocation, and workload performance in light of the organization's overarching goals and objectives. Strategic cloud analysis may provide insights into how well cloud deployments are supporting the business strategy, indicate where improvements or adjustments are needed, and guide decision-making for future cloud investments and initiatives, among others.

Illustrative embodiments include predicting a plurality of strategies associated with a cloud workload. “Predicting,” as used herein, may refer to the process of using data and algorithms to estimate desired information. For example, predicting a strategy in the context of cloud computing workloads might involve estimating a future strategy of a cloud workload based on current data, historical data, manual inputs, or any other data. A “strategy,” as used herein, may refer to a high-level plan or approach designed to achieve a specific goal or outcome. For example, a strategy in a business context might involve focusing on customer service to increase customer loyalty and boost revenue. A “cloud workload,” as used herein, may refer to a computing task or group of tasks that are hosted and run in a cloud environment. For example, a cloud workload might be a web application that is hosted on a cloud server and accessed by users over the internet.

Predicting a strategy associated with a cloud workload may include collecting data associated with the cloud workload, including its functional aspects, performance metrics, and related business objectives, and predicting strategies associated with that workload. For example, a cloud workload associated with data processing may be linked with strategies such as cost reduction, performance optimization, or data security enhancement.

In some embodiments predicting a strategy may include using a workload strategy predictor. A “workload strategy predictor,” as used herein, may refer to a tool or algorithm that uses data about a cloud workload to predict the most suitable strategies for managing that workload. For example, a workload strategy predictor might analyze data about a cloud-based data processing task to suggest strategies related to cost reduction, performance optimization, or data security. This workload strategy predictor may leverage machine learning algorithms to generate the most likely strategic components based on the cloud workload data. For example, if the cloud workload is related to customer service, the workload strategy predictor might suggest strategies related to improving customer experience or reducing response times.

Illustrative embodiments include presenting the predicted plurality of strategies to a user for selection of a strategy. This process may include generating a user interface that displays the predicted strategies and allows the user to select one or more strategies that align with the organization's objectives. For example, the interface might present strategies in a list or matrix format with details about each strategy's potential benefits and risks.

For example, when dealing with new workloads, a user might want to create a new workload and select corresponding workload or technology boilerplate as per their requirements. The user may then categorize the new workload as either “core” or “supporting.” A core workload may be directly related to a primary product or service offered by the organization, while a supporting workload may encompass all other types of products or services. Following this, the user may be presented with a list of strategic components that may be pertinent to their organization, such as faster time-to-market, innovation, cost leadership, and easy mergers and acquisitions. The user may then select one or more of these strategic components. Once the strategic components are identified, a set of target technology profiles or target technology profile combinations may be recommended to the user, based on the selections. The user may have the flexibility to either select these recommended profiles or override them. If the user selects to override the recommendations, they may manually fill in parameters to customize the technology profiles. Subsequently, a set of deployment patterns or target deployment profile combinations may be suggested. Once again, the user may have the discretion to either accept these recommendations or override them, the latter requiring manual input of parameters, as dictated by the technology strategic potential system and deployment potential system. The process may further involve storing the strategic information in a data store. This step may ensure that the chosen strategic components, technology profiles, and deployment patterns are accurately recorded and can be referenced in the future for further strategy modifications or reference.

Illustrative embodiments include predicting a technology for the cloud workload having a technology strategic potential value based on a selected strategy. A “technology,” as used herein, may refer to tools, systems, or software that support or enable computing tasks. For example, a technology in a cloud computing context might be a specific type of database software that supports data storage and retrieval for a cloud workload. A “technology strategic potential value,” as used herein, may refer to a quantitative or qualitative assessment of how well a technology supports a particular strategy, taking into account factors like cost and capability. For instance, the technology strategic potential value of a distributed database technology might be high if the strategy involves scaling up a data-intensive cloud workload.

For example, by analyzing exception logs, the frequency of “OutOfMemoryError” exceptions can be determined, which suggests increased operational costs. In technologies such as Java 10 or later containers that can dynamically increase memory and CPU allocation, these exceptions can be reduced, suggesting a higher technology strategic potential value when addressing a strategy component of reducing operations cost through self-optimization, in comparison to earlier versions of Java or Python containers. Similarly, performing sentiment analysis on user feedback for different UI technologies (e.g., Angular, Spring MVC, DotNet Core, React JS) can reveal which technology contributes to more positive user experiences, thereby revealing a higher technology strategic potential value for a specific technology when addressing a strategy component of differentiation. Further, analysis of end user data can also reveal which technologies engage users for longer periods, thus suggesting their strategic advantage. For instance, when users spend more time interacting with eBooks developed with a “Flip PDF” technology compared to normal PDFs, it may suggest a higher technology strategic potential value for “Flip PDF” technology when addressing a strategy component of differentiation.

Predicting a technology for the cloud workload having a technology strategic potential value based on a selected strategy may involve analyzing the selected strategy and determining which technologies are most likely to support that strategy effectively and cost-efficiently. For example, if the selected strategy involves scaling up the cloud workload, the system might predict that a distributed database technology has a high strategic potential value.

In some embodiments, predicting a technology may include using a strategic technology predictor. A “strategic technology predictor,” as used herein, may refer to a tool or algorithm that predicts the most suitable technology for a cloud workload based on a selected strategy and the specifics of the workload. For example, a strategic technology predictor might suggest that a particular type of machine learning algorithm is the most suitable technology for a cloud workload that involves predictive analytics. This predictor may utilize machine learning algorithms and a technology data set to determine the most suitable technology based on the selected strategy and the specific characteristics of the cloud workload. For example, the predictor might use data on past technology performance, industry trends, and cost data to generate its predictions.

In some embodiments, the strategic technology predictor may comprise a machine learning model configured to identify a plurality of technologies based on the cloud workload and the selected strategy. This machine learning model may be trained using historical technology performance data, cloud workload data, and strategy data to make accurate and robust predictions. For example, it may consider factors like technology compatibility, cost-effectiveness, and scalability.

In some embodiments, a technology strategic potential value may be based at least in part on technology capability and technology cost. A “technology capability,” as used herein, may refer to the functional abilities or performance characteristics of a technology. For example, the technology capability of a database software might include its ability to handle a certain number of transactions per second or its support for specific types of data queries. A “technology cost,” as used herein, may refer to the total expenditure associated with implementing and maintaining a technology. For example, the technology cost of a specific type of database software might include the purchase price, the cost of installation and configuration, and ongoing costs for updates, support, and maintenance. Thus, the technology strategic potential value may represent a quantitative assessment of how well a technology supports the selected strategy while also considering the cost of implementing and maintaining that technology. For example, a highly capable but expensive technology might have a similar strategic potential value to a less capable but more affordable technology.

Illustrative embodiments include predicting a deployment for the cloud workload having a deployment strategic potential value based on the selected strategy. A “deployment,” as used herein, may refer to the process of installing, configuring, and running a computing task or workload in a specific environment. For example, deployment of a web application might involve installing the application on a cloud server, configuring it to work with a particular database, and ensuring it is accessible to users over the internet. A “deployment strategic potential value,” as used herein, may refer to a quantitative or qualitative assessment of how well a deployment option supports a particular strategy, taking into account factors like cost and capability. For example, the deployment strategic potential value of a private cloud might be high if the strategy involves enhancing data security.

Predicting a deployment for the cloud workload having a deployment strategic potential value based on the selected strategy may involve analyzing the selected strategy and the cloud workload to identify suitable deployment options. For example, if the selected strategy involves improving data security, the system might predict that a private cloud deployment has a high strategic potential value.

In some embodiments, predicting a deployment may include using a strategic deployment predictor. A “strategic deployment predictor,” as used herein, may refer to a tool or algorithm that predicts the most suitable deployment option for a cloud workload based on a selected strategy and the specifics of the workload. For example, a strategic deployment predictor might suggest that a hybrid cloud deployment is the most suitable option for a cloud workload that involves handling sensitive data. This predictor may employ machine learning algorithms and a deployment data set to determine the most suitable deployment pattern based on the selected strategy and the specifics of the cloud workload. For example, the predictor might consider data on past deployment successes, industry trends, and cost factors.

In some embodiments, the strategic deployment predictor may comprise a machine learning model configured to identify a plurality of deployments based on the cloud workload and the selected strategy. This machine learning model may be trained using historical deployment data, cloud workload data, and strategy data to make accurate and nuanced predictions. For example, it may consider factors like deployment scalability, cost-effectiveness, and security.

In some embodiments, a deployment strategic potential value may be based at least in part on deployment capability and deployment cost. A “deployment capability,” as used herein, may refer to the functional abilities or performance characteristics of a deployment option. For example, the deployment capability of a private cloud might include its ability to offer high levels of data security and control over the computing environment. A “deployment cost,” as used herein, may refer to the total expenditure associated with implementing and maintaining a deployment option. For example, the deployment cost of a public cloud deployment might include fees for data storage and processing, costs for data transfer, and any charges for additional services like data backup or security features. Thus, the deployment strategic potential value may represent a quantitative assessment of how well a deployment option supports the selected strategy while also considering the cost of implementing and maintaining that deployment. For example, a highly secure but expensive private cloud deployment might have a similar strategic potential value to a less secure but more affordable public cloud deployment.

Illustrative embodiments include executing the strategic technology predictor to identify another technology for the cloud workload having a greater technology strategic potential than the technology strategic potential value of a previous technology. This process may involve re-running the strategic technology predictor, considering changes in the cloud workload, the selected strategy, and the technology landscape. For example, a new, more affordable technology might have emerged that has a higher strategic potential value than the previously selected technology.

Illustrative embodiments include executing the strategic deployment predictor to identify another deployment for the cloud workload having a greater technology strategic potential than the technology strategic potential value of a previous deployment. This process may involve re-running the strategic deployment predictor, considering changes in the cloud workload, the selected strategy, and the deployment landscape. For example, the organization might have increased its IT budget, making a more expensive but higher-performing deployment option more attractive.

Illustrative embodiments include storing a strategic decision comprising the cloud workload, the selected strategy, the first technology, and the first deployment. This process may involve recording the strategic decision in a database for future reference and to support continuous improvement processes. For example, the system might store details about the cloud workload, the reasons for the selected strategy, and the expected benefits of the chosen technology and deployment.

Illustrative embodiments include transmitting a strategic alert. A “strategic alert,” as used herein, may refer to a notification or advisory message generated by a system, tool, or process that provides guidance or information related to an organization's strategic objectives. These alerts could be related to technology choices, resource allocation, or workload adjustments, among other things, with the intention of maintaining alignment with the overall business strategy. They may serve to inform decision-makers of potential opportunities, challenges, or changes that could impact the strategic alignment of their operations, including those in a cloud-based environment. Non-limiting examples of strategic alerts include e-mail messages, application notifications (e.g., web-based or mobile phone-based applications), mobile phone messages, and the like.

In some embodiments, a strategic alert may be transmitted on a pre-determined schedule. This process may involve the automatic generation and sending of notifications to relevant stakeholders to keep them updated on the status of the cloud workload and its strategic alignment. For example, the system might send monthly alerts summarizing the strategic alignment of the cloud workload and highlighting any significant changes or issues.

Illustrative embodiments include generating a strategic report. A “strategic report,” as used herein, may refer to a comprehensive document or presentation that provides an overview of an organization's strategic position. It may include information about the organization's goals, initiatives, key performance indicators, and progress towards these goals. It might also include analysis of external factors such as market trends and competitive landscape, as well as internal factors like resources, capabilities, and performance. The strategic report may be used as a tool for decision-making and communication, providing stakeholders with a clear understanding of the organization's strategic direction and its alignment with ongoing activities and initiatives. Non-limiting examples of strategic reports include web-based or mobile phone-based application displays, spreadsheets, text-based documents (e.g., Word or PDF documents), and the like.

In some embodiments, a strategic report may depict an overview of the cloud workload, the selected strategy, the first technology, and the first deployment. This report may be designed to provide a comprehensive yet concise summary of the strategic decision-making process and its outcomes. For example, it might include charts showing the strategic potential values of different technologies and deployments, along with a narrative explanation of the chosen strategy and its expected benefits.

Illustrative embodiments include providing continuous strategic alignment. “Continuous Strategic Alignment,” as used herein, may refer to an ongoing process of aligning technological resources and operations with the strategic goals and objectives of an organization, ensuring that all elements contribute towards these objectives in a harmonious and effective manner. An embodiment, for instance, may continuously provide strategic alerts, advising customers on technology choices, resource allocation, and strategic suggestions to ensure that the workload fulfills its intended strategic purpose, thus maintaining a continuous strategic alignment of cloud workloads. This process may provide strategic insights and suggestions for workload management and resource allocation in a cloud environment.

For example, an embodiment may facilitate the porting of a business strategy to the cloud and establish a direct connection between an organization's strategy and its cloud workloads. This process may involve identifying the types of workloads required to support the strategy, mapping these workloads against strategic components directly on the cloud console. For instance, the embodiment may map the workloads to a product or service's cost versus differentiation or another strategic component. Using metrics from operations, usage, and stakeholders' feedback, it may continuously evaluate the value realization against the strategy that's driving the workload. This process may offer an end-to-end value realization picture against cloud investment for a given workload, tying the organization's strategy to its cloud architecture through detailed mapping, analysis, and recommendations on workloads.

Illustrative embodiments include presenting a strategic decision to alter a cloud workload. Presenting a strategic decision may include conveying, displaying, or providing information or recommendations to a user (e.g., a stakeholder). This could be in the form of a report, a dashboard update, a notification, an alert, or any other method that effectively communicates the suggested changes to the individuals responsible for managing or making decisions about the cloud workload. Such a presentation may provide information in a way that enables informed decision-making and effective action, such as by providing information to relevant stakeholders in an accessible, understandable, and actionable manner.

For example, presenting a suggestion to alter a cloud workload may involve recommending changes to a cloud-based workload based on various factors such as strategic alignment, technological advancements, efficiency, cost considerations, or changes in organizational strategy. This may involve recommendations on the use of different cloud services, adjustments in resource allocation, updates or modernization of the workload's technology stack, or other alterations aimed at optimizing the performance, cost-effectiveness, and/or strategic alignment of the workload, among other considerations. These suggestions may be based on ongoing analysis and evaluation of the workload's performance and the organization's strategic needs. For example, an embodiment may provide suggestions to reshape a workload based on any sudden changes in organizational strategy through strategic analysis and may advise on changes related to the workloads accordingly.

Illustrative embodiments include presenting a strategic cloud view. Presenting a strategic cloud view may involve providing a representation or overview of an organization's cloud operations in the context of its strategic objectives. This might involve displaying how cloud workloads align with the business strategy, visualizing the strategic contribution of different cloud services, or illustrating how changes in the cloud environment could impact strategic outcomes. The goal of such a presentation may be to provide decision-makers with a clear, holistic understanding of how the organization's cloud operations support its strategic initiatives, enabling them to make more informed and strategic decisions about their cloud investments and activities. For example, an embodiment may offer a strategic cloud view of an organization to the CIO/CEO's office, providing a clear connection between the cloud workloads and various strategic initiatives they are striving to achieve. Suggestions on required changes to workloads based on the latest technological advancements for continuous cost leadership or differentiation may be part of such a presentation.

Illustrative embodiments include performing cloud strategy integration. “Cloud strategy integration,” as used herein, may refer to the process of aligning an organization's cloud operations and workloads with its overall strategic objectives during migration from on-premises to the cloud. In an embodiment, for instance, a workload that is migrating from on-premises to the cloud may go through one or more integration stages before reaching a state where it is fully integrated with the organization's strategy, or any changes to that strategy. This may indicate that the workload not only operates efficiently within the cloud environment but also actively contributes to the fulfillment of the organization's strategic objectives. Cloud strategy integration may thus provide a harmonized and strategic utilization of cloud technologies, effectively bridging the gap between strategic objectives and cloud operations.

In one non-limiting example, the cloud strategy integration may include a lifting and shifting stage, which may be an initial phase of migrating an application or workload from an on-premises environment to the cloud without making significant modifications. The goal during this stage may be primarily to replicate the on-premises infrastructure in the cloud as closely as possible.

Moreover, the cloud strategy integration process may include a cloud optimization stage, where an organization may take advantage of cloud-specific features and capabilities to improve efficiency, performance, or cost-effectiveness. This might involve, for instance, adjusting resource allocation based on demand patterns, implementing auto-scaling, or adopting cloud-native storage options. The aim during this stage may be to optimize the operation and management of the migrated workloads to better exploit the benefits of the cloud environment.

Furthermore, the cloud strategy integration process may include a cloud modernization stage, which may involve the process of re-engineering or re-architecting an application or workload to take full advantage of cloud-native architectures and services. This process may involve adopting microservices architectures, containerization, serverless computing, or other modern cloud technologies. The goal during this stage may be to leverage the scalability, flexibility, and innovation possibilities of the cloud.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The process software for strategic cloud management is integrated into a client, server and network environment, by providing for the process software to coexist with applications, operating systems and network operating systems software and then installing the process software on the clients and servers in the environment where the process software will function.

The integration process identifies any software on the clients and servers, including the network operating system where the process software will be deployed, that are required by the process software or that work in conjunction with the process software. This includes software in the network operating system that enhances a basic operating system by adding networking features. The software applications and version numbers will be identified and compared to the list of software applications and version numbers that have been tested to work with the process software. Those software applications that are missing or that do not match the correct version will be updated with those having the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems, including the network operating systems, will be identified and compared to the list of operating systems, version numbers and network software that have been tested to work with the process software. Those operating systems, version numbers and network software that do not match the list of tested operating systems and version numbers will be updated on the clients and servers in order to reach the required level.

After ensuring that the software, where the process software is to be deployed, is at the correct version level that has been tested to work with the process software, the integration is completed by installing the process software on the clients and servers.

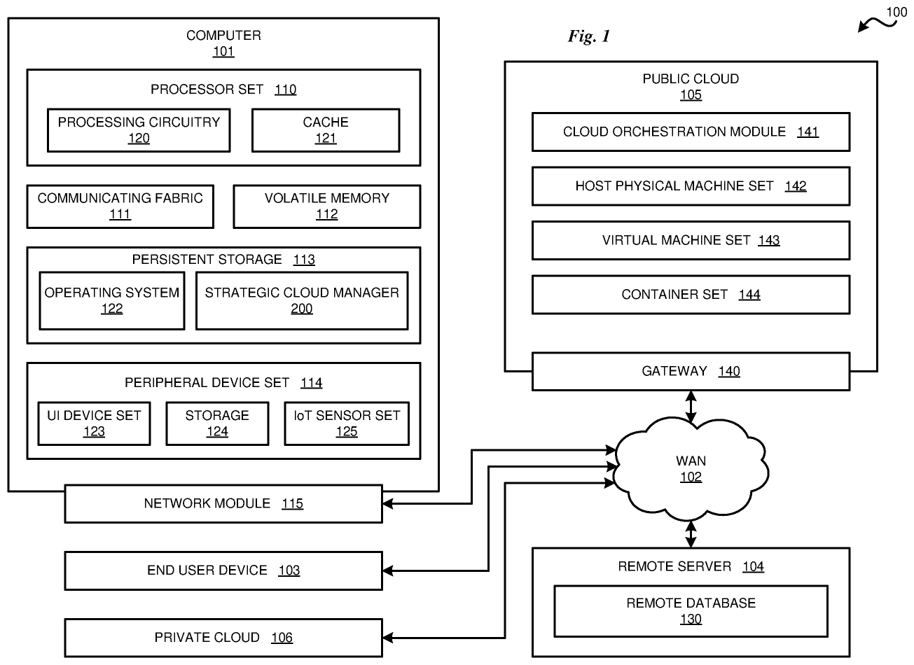

With reference to FIG. 1, this figure depicts a block diagram of a computing environment 100. Computing environment 100 contains an example of an environment for the execution of at least some of the computer code involved in performing the inventive methods, such as strategic cloud manager 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

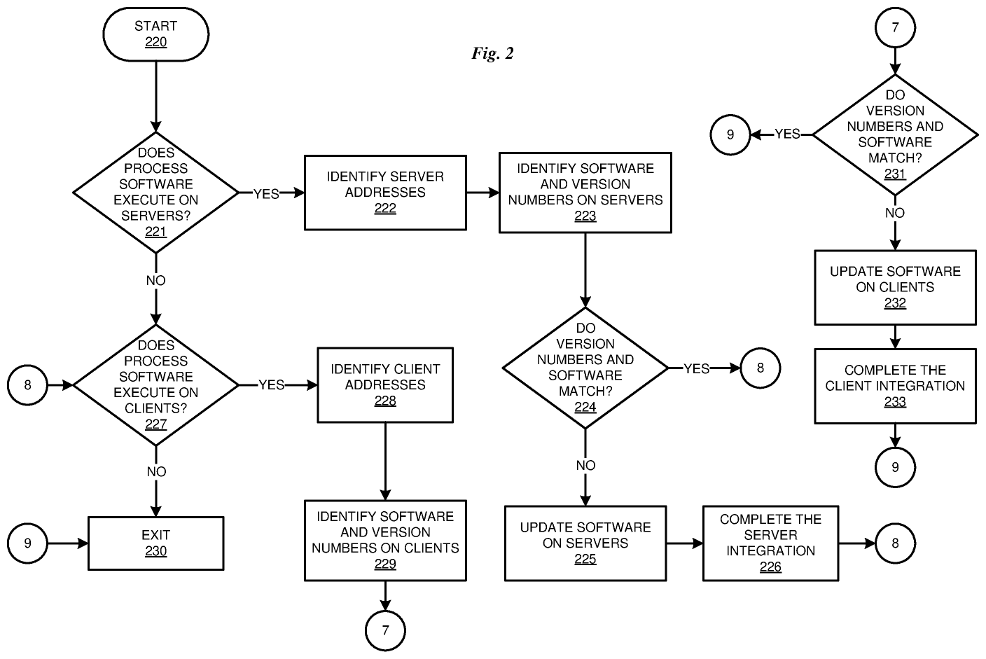

With reference to FIG. 2, this figure depicts a block diagram of an example software integration process, which various illustrative embodiments may implement. Step 220 begins the integration of the process software. An initial step is to determine if there are any process software programs that will execute on a server or servers (221). If this is not the case, then integration proceeds to 227. If this is the case, then the server addresses are identified (222). The servers are checked to see if they contain software that includes the operating system (OS), applications, and network operating systems (NOS), together with their version numbers that have been tested with the process software (223). The servers are also checked to determine if there is any missing software that is required by the process software (223).

A determination is made if the version numbers match the version numbers of OS, applications, and NOS that have been tested with the process software (224). If all of the versions match and there is no missing required software, the integration continues (227).

If one or more of the version numbers do not match, then the unmatched versions are updated on the server or servers with the correct versions (225). Additionally, if there is missing required software, then it is updated on the server or servers (225). The server integration is completed by installing the process software (226).

Step 227 (which follows 221, 224 or 226) determines if there are any programs of the process software that will execute on the clients. If no process software programs execute on the clients, the integration proceeds to 230 and exits. If this not the case, then the client addresses are identified (228).

The clients are checked to see if they contain software that includes the operating system (OS), applications, and network operating systems (NOS), together with their version numbers that have been tested with the process software (229). The clients are also checked to determine if there is any missing software that is required by the process software (229).

A determination is made if the version numbers match the version numbers of OS, applications, and NOS that have been tested with the process software (231). If all of the versions match and there is no missing required software, then the integration proceeds to 230 and exits.

If one or more of the version numbers do not match, then the unmatched versions are updated on the clients with the correct versions 232. In addition, if there is missing required software, then it is updated on the clients 232. The client integration is completed by installing the process software on the clients 233. The integration proceeds to 230 and exits.

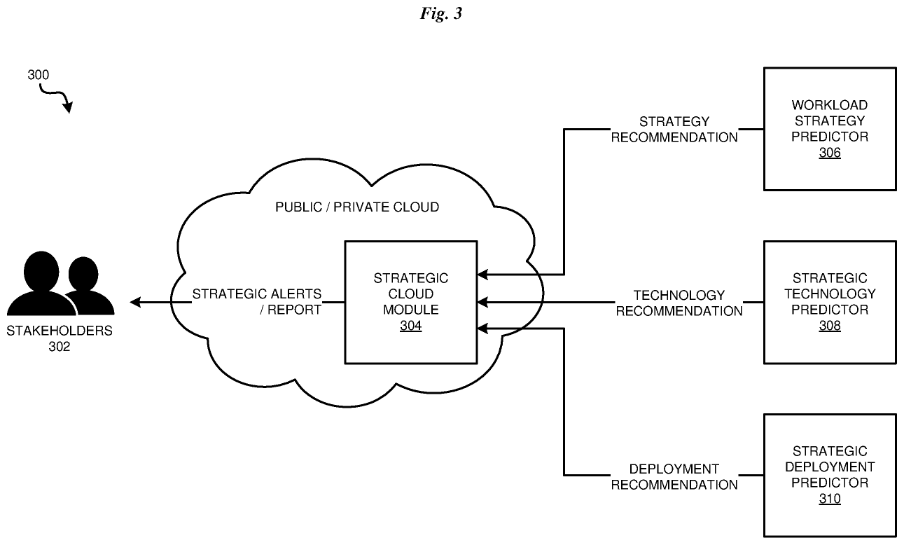

With reference to FIG. 3, this figure depicts an example diagram for strategic cloud management system 300, which various illustrative embodiments may be a part of. Strategic cloud management system 300 may interact with stakeholders 302, and it may comprise strategic cloud module 304, workload strategy predictor 306, strategic technology predictor 308, and strategic deployment predictor 310.

Stakeholders 302 may represent any individual, group, or organization that has a vested interest in the processes and outcomes of a project, task, or business decision. This could include internal parties such as project team members, employees, managers, and executives, as well as external parties such as clients, suppliers, investors, and regulators. In the case of cloud workload management and strategic alignment, stakeholders may also involve parties who are directly involved in or affected by the deployment, operation, and performance of cloud workloads, such as IT staff, cloud service providers, and end users of the cloud-based services.

Strategic cloud module 304 may align workloads with organizational strategies and provide strategic alerts and reports for stakeholders 302. The strategic cloud module may be configured to map each workload against one or more strategic components. Using the recommendations generated by the workload strategy predictor, for instance, users of the strategic cloud module may align each workload with the strategic elements it supports. Additionally, the system may also allow for the manual addition of new strategies, ensuring the flexibility to adapt to dynamic strategic landscapes.

Moreover, the strategic cloud module may be responsible for defining, mapping, and storing the interconnections between recommendations from workload strategy predictor 306, strategic technology predictor 308, and strategic deployment predictor 310 for each application layer of workloads. By storing and managing these complex relationships, the strategic cloud module may facilitate a nuanced understanding of how the different components and layers of workloads support strategic objectives.

Furthermore, the strategic cloud module may generate strategically important views of cloud workloads for various stakeholders. This feature may empower stakeholders to understand the strategic role of cloud workloads in the broader organizational context. By visualizing how a set of cloud workloads supports a given organizational strategy, or how a single cloud workload supports multiple organizational strategies, stakeholders may gain a clear and comprehensive view of the strategic alignment of cloud workloads.

Workload strategy predictor 306 may maintain the strategic alignment of cloud workloads. In some embodiments, it may use artificial intelligence processes to anticipate and guide organizational strategies. The workload strategy predictor may predict relevant organization strategies for each cloud workload. It may, for example, use artificial intelligence to discern which strategic factors are most pertinent to each cloud workload within an organization. By doing so, the system may be able to link specific workloads with the strategic components they most contribute to, facilitating a comprehensive understanding of how each workload aligns with, and helps to achieve, the broader organizational strategies.

Moreover, the workload strategy predictor may be configured to identify any changes in the associated strategy for an existing workload. As strategies evolve over time due to various internal and external factors, this function may ensure that workloads remain in alignment with current strategic goals. When the system discerns a shift in strategy, it may issue a strategic alert or report to relevant stakeholders. This continuous monitoring and alerting system may ensure that any shifts in strategic objectives are swiftly identified and communicated. Consequently, organizations can adjust their workloads promptly and appropriately to maintain strategic coherence, optimize resource allocation, and effectively fulfill their strategic objectives.

For example, the workload strategy predictor's prediction process may begin with the collection of pertinent data from various sources within the organization, such as strategy-related documents and departmental records. It may then analyze the data using a combination of natural language classifiers (NLC), discovery API, parsers, sentiment analysis tools, or any other suitable process. The aim of this processing may be to discern and pinpoint the organization's strategic components as they apply to cloud workloads, application layers, or architectural layers. Once this preliminary analysis is done, a user (e.g., the CIO or CEO's office) may fine-tune these strategic components for application or architectural layers, taking into consideration parameters such as types and functionalities. After this fine-tuning process, the workload strategy predictor may leverage machine learning to train a model capable of predicting the top five strategies (although any other number may be used) for the organization's cloud workloads or architectural layers, based on type, functionality, and other relevant factors. Consequently, the workload strategy predictor can provide strategic guidance by predicting the most suitable strategic components for different aspects of the organization's cloud architecture.

Strategic technology predictor 308 may be configured to predict the most suitable technologies for each application or architectural layer of the workload. This prediction may be based on the capacity and cost of each technology in relation to the strategies associated with that workload. This may ensure that the technologies deployed in each layer of the workload are best suited to contribute towards the strategic objectives of the organization. The strategic technology predictor may utilize one or more artificial intelligence methodologies.

The role of the strategic technology predictor may extend beyond the initial selection of technologies. On a periodic basis, it may check for the availability of any improved technologies for each application or architectural layer of a workload. It may evaluate these opportunities based on whether they can better fulfill associated strategy elements, for example, by taking into account strategic capability and cost. When it identifies better alternatives, the strategic technology predictor may send a strategic alert or report to stakeholders. This proactive alert system may ensure that relevant parties are promptly informed about potential opportunities for strategic improvement.

For example, the strategic technology predictor's prediction process may begin with the acquisition of data from a variety of sources, including feedback from users, developers, and product owners, online documents, and cloud APIs for cost estimation. It may then analyze the data using tools such as natural language classifier (NLC), discovery API, parsers, sentiment analysis, and any other suitable process. The objective may be to establish a comparative score for strategic capability and cost, including factors like license cost, development cost, and deployment cost. Once the preliminary analysis is complete, a user (e.g., architects and developers) may fine-tune the comparative score data for strategic capability and cost. Following this fine-tuning phase, a machine learning model may be trained to predict the top five technologies (although any other number may be used) that provide higher capability and lower cost for a given strategy. Consequently, the strategic technology predictor can proactively identify and suggest the top technologies that offer higher strategic capabilities at lower costs.

Strategic deployment predictor 310 may be configured to predict the most suitable deployment for each application or architectural layer of the workload. These predictions may be made with a focus on capability and cost-effectiveness, as they pertain to the strategies associated with the workload. The goal may be to ensure that the deployment selected for each layer of the workload are optimally geared towards the strategic goals of the organization. The strategic deployment predictor may utilize one or more artificial intelligence methodologies.

Moreover, the strategic deployment predictor may periodically check for the availability of any improved deployment for each application or architectural layer of a workload. The evaluation of these alternatives may be based on their potential to better fulfill the strategy elements, such as by considering their strategic capability and cost. Whenever this predictor identifies more suitable alternatives, it may send out strategic alerts or reports to stakeholders. This alert system may ensure that any possible opportunities for strategic improvement are swiftly communicated to relevant parties.

For example, the strategic deployment predictor's prediction process may start with gathering pertinent data from multiple sources. These can include feedback from users, developers, and product owners, online documentation, and cloud APIs for cost information. It may then analyze the data using tools such as natural language classifier (NLC), discovery tools, parsers, sentiment analysis, and any other suitable process. The aim may be to derive a comparative score for strategic capability and cost, considering factors such as license cost, development cost, and deployment cost. Following this initial analysis, the comparative score data for strategic capability and cost is then fine-tuned by a user (e.g., subject matter experts). The strategic deployment predictor then uses this refined data to train a machine learning model, with the objective to predict the top five deployments (although any other number may be used) that offer higher capability and lower cost for a given strategy. As a result, the strategic deployment predictor may be capable of foreseeing and recommending the top deployments that deliver greater strategic value and cost efficiency.

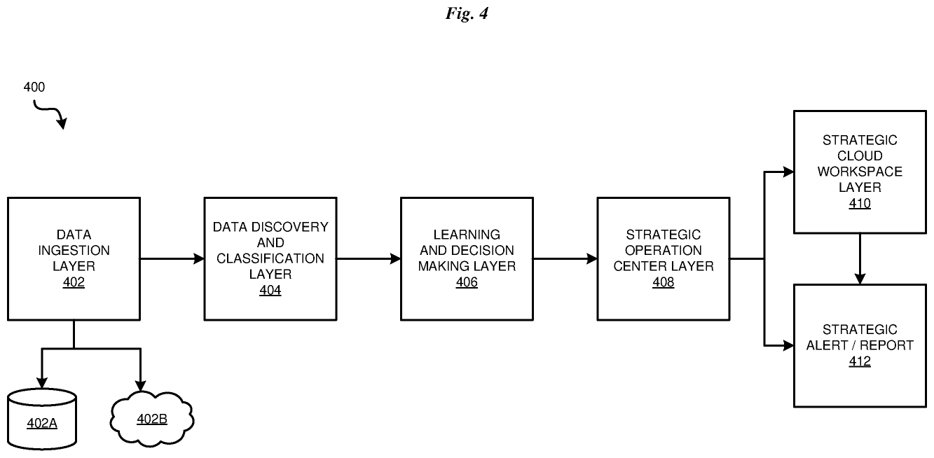

With reference to FIG. 4, this figure depicts a block diagram of an example strategic cloud manager 400, which various illustrative embodiments may implement. It is to be understood that the strategic cloud manager 400 may be implemented as a single unit or as a part of a larger system in which computer-usable program code or instructions implementing the processes may be located for the illustrative embodiments. In addition, strategic cloud manager may comprise multiple strategic cloud managers integrated into a single unit or functioning separately.

In the depicted example, strategic cloud manager 400 includes data ingestion layer 402, data discovery and classification layer 404, learning and decision-making layer 406, strategic operation center (SOC) layer 408, strategic cloud layer 410, and alert/report 412.

Data ingestion layer 402 may be responsible for the collection and processing of various data types, including structured, semi-structured, and unstructured data. The data ingested may pertain to different facets of an organization's operations, including strategic considerations, technological aspects, cloud hosting approaches, deployment patterns, and associated costs, among others. Furthermore, the layer may also collect feedback from a wide range of stakeholders within the organization, such as developers, product owners, end users, architects, and operations personnel. This comprehensive data collection may provide a rich and diverse source of information that can facilitate strategic alignment and decision making.

The data sources feeding into this layer can be broadly categorized into internal and external sources. Internal sources, illustrated by database 402a, may include documentation and discussions within the organization. These may comprise documents, minutes of meetings, executive discussions, planning meetings, product owner's meetings, departmental discussions, application information documents, architecture-related documents, operational data, or any other data. On the other hand, external sources, illustrated by network 402b, may be data outside of the organization's information, such as industry-related resources. They may include online industry articles, benchmarking-related information, blogs, industry journals, and other publications. These sources may provide the organization with insights into broader industry trends, benchmarks, and best practices, adding another dimension to the strategic analysis.

Data discovery and classification layer 404 may process data (such as data collected by data ingestion layer 402) to discern and categorize relevant information. This layer may process a range of source information, whether structured, semi-structured, or unstructured, and may utilize non-machine learning methods and/or machine learning methods to identify critical information. Such processes may include performing natural language processing (NLP), topic modeling, sentiment analysis, entity recognition, or any other suitable process. In addition, this layer may employ machine learning algorithms for pattern recognition, anomaly detection, classification, or any other suitable machine-learning process. Further, this layer may extract strategies, compare strategic potential scores of technologies and deployments, and identify changes in strategic directions of existing workloads.

Additionally and alternatively, the data discovery and classification layer may assess and compare the strategic potential scores of various technologies and deployments for a given strategy. These scores may be based on feedback gathered from various stakeholders, such as end users, developers, architects, product owners, and industry experts. It may also identify any changes in the strategic orientation of existing workloads. This detailed information may be gathered for each workload in relation to a specific strategy, and it can be stratified further per industry, line of business, application business functions, or application layer.

The output from the data discovery and classification layer may be organized into a suitable format, such as JSON format, which may be fed into another system (e.g., learning and decision-making layer 406). The aim of this process may be to ensure higher confidence and accuracy of the data, thereby supporting more informed and reliable decision-making within the organization.

Learning and decision-making layer 406 may arrive at a strategic decision. It may, for example, determine the strategic components for workloads, identify the most suitable technology and deployments to fulfill these strategic components, and evaluate comparative strategic potential scores and associated implementation costs for technologies and deployments against given strategic components. Furthermore, it may also discern if there's any change in the associated strategy for existing workloads.

In one embodiment, this layer leverages two distinct sets of machine learning models to make strategic decisions based on the feed from the previous layer. The first set may be a decision model, which may employ various decision algorithms to analyze the information gathered and classified by data discovery and classification layer 404. The second set of machine learning models may collect additional data from manual entries and fine-tuning at the strategic operation center layer 408, which may then be used to train the decision model. These insights may enable the learning and decision-making layer 406 to offer precise, actionable recommendations for decision-making, ensuring the alignment of technology and deployment choices with the organization's overarching strategic objectives.

Training the decision model may involve an iterative process that aims to optimize the model's performance over time. Any errors or discrepancies between the predicted and actual results may be used to adjust the model's parameters, such as weights in the case of a neural network. In the context of the decision model, these weights may represent the importance of different features or variables in making strategic decisions. If a particular feature consistently leads to accurate predictions, the weight associated with that feature may be increased, implying a greater influence on the decision-making process. Conversely, if a feature tends to result in inaccurate predictions, the weight associated with that feature may be decreased, thereby reducing its influence. This process of adjusting weights may continue iteratively, with the model progressively improving and refining its decision-making capabilities over time through a process known as learning. By optimizing these weights, the decision model can make more accurate and robust decisions, thereby enhancing the strategic alignment of cloud workloads.

Strategic operation center layer 408 may enable manual input for decision model training. It may receive user input in regard to the system's strategic decision. For example, this layer may be overseen by strategy operations center analysts, who may be specialists equipped with strategic and technological knowledge and may be tasked with supervising the output from the system, providing an additional level of scrutiny and adjustment as needed. Strategic operation center layer 408 may provide user feedback for training the decision model based on the feedback, helping to refine and the system's strategic decision recommendations. This manual adjustment and intervention process may serve to increase the accuracy and effectiveness of the strategic decisions from the system.

Further, the modifications made in strategic operation center layer 408 may be fed into strategic cloud layer 410, which may help ensure that the final output, incorporating both machine learning insights and human expertise, closely aligns with the organization's strategic objectives, thus enhancing the reliability of the decision-making. In some embodiments, strategic operation center layer 408 may be used during an initial training phrase only, after which strategic operation center layer 408 may be skipped, implemented sparingly, or employed based on certain criteria (e.g., when there is a low confidence associated with the strategic decision).

Strategic alert or report 412 may notify users or stakeholders of strategic decisions or effects related thereto. For example, in the context of existing workloads, the strategic alert or report may provide critical notifications triggered by various factors that may impact the strategic alignment of the workload. A strategic alert may be sent due to a strategic shift arising from changes in the strategic requirement that the workload fulfills. These shifts could represent a realignment or transformation in the organization's strategic objectives, thus necessitating adjustments to the workload's configuration or deployment.

Additionally, a strategic alert might be triggered due to a strategic shift prompted by feedback from operations or social media channels. Such feedback could reveal insights about the performance, utility, or perceived value of the workload, which could lead to strategic realignments. Moreover, a technology shift can instigate a strategic alert. This shift can occur when a new target technology profile, or a combination of target technology profiles, becomes available. If this new target technology profile (or combination) can fulfill the strategic requirement in a more effective manner compared to the current target technology profile, a strategic alert may be sent to suggest a possible technology switch.

Further, a deployment shift can also precipitate a strategic alert. Such a shift might occur when a more cost-effective deployment profile becomes available that aligns better with an existing strategic component for a given workload. This could present an opportunity to optimize costs while maintaining or enhancing strategic alignment. A strategic report may include the same or similar information as provided in the strategic alert, including the examples above, in document format that may be downloaded or viewed at the convenience of the user or stakeholder.

In some embodiments, in the context of continuous strategic alignment, a strategic alert or report may notify users of new strategic alignments and technological innovations. For example, if a strategic decision proposes a new technology stack profile for further strategic fulfillment, the strategic alert or report may notify users of this new proposal. The strategic decision can address key strategic needs, such as fostering differentiation, accelerating time-to-market, fostering innovation, promoting cost leadership, or facilitating easier mergers and acquisitions. These proposals can be applied to both existing and new workloads and may be informed by trending industry practices.

Additionally, a strategic alert or report may notify a user that the strategic decision suggests a new deployment profile based on the availability of more cost-effective or strategically advantageous options for existing workloads. This can include enhancements in scalability, availability, and portability, among others. Such a proactive approach may ensure that workloads are always running in the most optimal deployment settings, thus maximizing operational efficiency.

Further, a strategic alert or report may notify the user that the strategic decision suggests modifying the aforementioned alerts to accommodate shifts in associated costs based on internal and external feedback. This may ensure that the most optimal technology or deployment is chosen at the most cost-effective rate. The feedback loop may allow for the adjustment and optimization of the cloud strategy in response to changing circumstances, minimizing risks and maximizing return on investment.

Furthermore, a strategic alert or report may notify stakeholders that the strategic decision proposes modifications to the strategy associated with each workload in response to shifts in the organization's overarching strategy. Each strategic component linked to an existing workload may be evaluated and modified as needed. This may ensure that workloads are continuously aligned with the dynamic nature of organizational strategy, providing agility and resilience in the face of changing business landscapes.

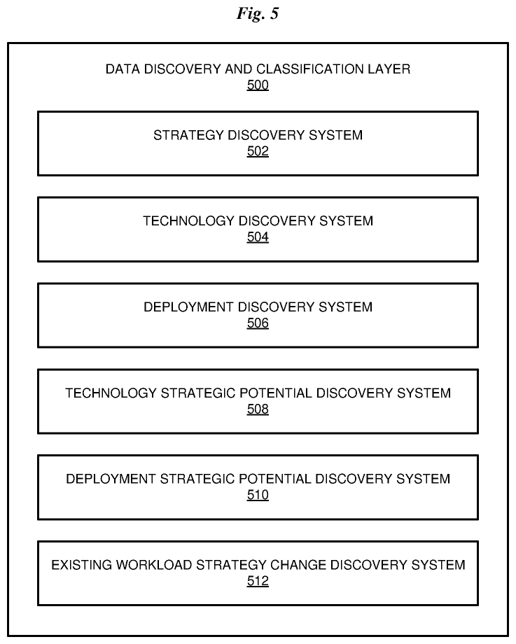

With reference to FIG. 5, this figure depicts a block diagram of an example data discovery and classification layer 500, which various illustrative embodiments may implement. It is to be understood that the data discovery and classification layer 500 may be implemented as a single unit or as a part of a larger system in which computer-usable program code or instructions implementing the processes may be located for the illustrative embodiments.

As shown, data discovery and classification layer 500 may comprise a strategy discovery system 502, a technology discovery system 504, a deployment discovery system 506, a technology strategic potential discovery system 508, a deployment strategic potential discovery system 510, and an existing workload strategy change discovery system 512.

Strategy discovery system 502 may be configured to discover and classify strategies. In some embodiments, it may utilize tools such as a natural language classifier and discovery tools or other suitable methodologies to investigate strategy elements. It may sift through available data, looking for strategic insights and patterns, and classify these into coherent strategies. This process may allow for the comprehensive understanding and interpretation of organizational strategies, serving as a foundation for subsequent systems.

Technology discovery system 504 may be configured to discover and classify technology components and related strategy capability against the strategies discovered by the strategy discovery system 502. In some embodiments, it may use tools like a natural language classifier, discovery tools, parsers, or other suitable methodologies to investigate technology aspects. This process may involve analyzing technical data to find technological components and evaluating their strategic potential against the previously discovered strategic components.

Deployment discovery system 506 may be configured to discover and classify deployments and related strategic capability against the strategies discovered by technology discovery system 504. In some embodiments, it may utilize a natural language classifier, discovery tools, or other suitable methodologies to seek out deployments. This part of the system may focus on understanding the various ways technology can be deployed to meet strategic goals, by analyzing potential deployment models and evaluating their strategic capabilities.

Technology strategic potential discovery system 508 may be configured to discover feedback from users (e.g., end users, developers, architects, product owners, and industry experts) for a technology pattern against each of the supported strategies. In some embodiments, it may use tools like a natural language classifier, discovery techniques, tone analysis, parsers, or other suitable processes to search for user feedback regarding a technology. The goal of this part of the system may be to understand how the technology is viewed and evaluated from various perspectives, and how it aligns with strategic components.

Deployment strategic potential discovery system 510 may be configured to discover feedback from users (e.g., end users, developers, architects, product owners, and industry experts) for a deployment against each of the supported strategies. In some embodiments, it may use tools like a natural language classifier, discovery tools, tone analysis, parsers, or other suitable processes to find feedback for a deployment. This process may help the system understand how different deployments are received by users and how they strategically align with the previously identified strategies.

Existing workload strategy change discovery system 512 may be configured to discover change in strategy for an existing workload. In some embodiments, it may utilize tools such as a natural language classifier, tone analysis, intent analysis, parsers, or any other suitable process to search for changes in strategy for an existing workload. Its function may be to ensure that any changes or shifts in strategic components associated with existing workloads are promptly identified and factored into the strategic alignment.

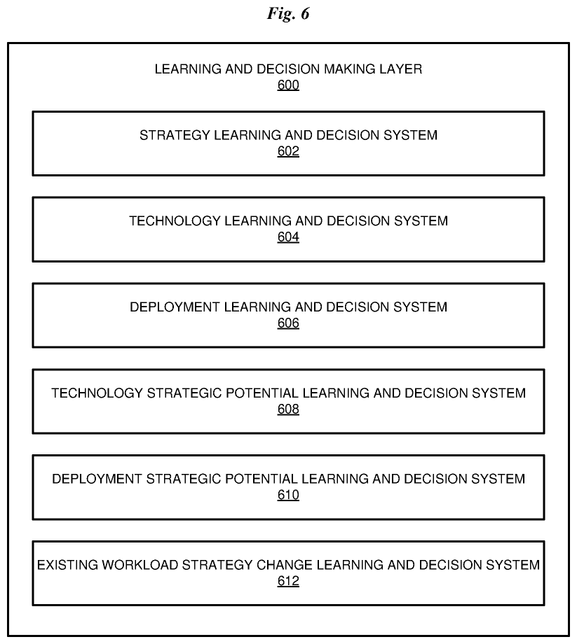

With reference to FIG. 6, this figure depicts a block diagram of an example data learning and decision-making layer 600, which various illustrative embodiments may implement. It is to be understood that the learning and decision-making layer 600 may be implemented as a single unit or as a part of a larger system in which computer-usable program code or instructions implementing the processes may be located for the illustrative embodiments.

As shown, learning and decision-making layer 600 may comprise a strategy learning and decision system 602, a technology learning and decision system 604, a deployment learning and decision system 606, a technology strategic potential learning and decision system 608, a deployment strategic potential learning and decision system 610, and an existing workload strategy change learning and decision system 612.

Strategy learning and decision system 602 may be configured to arrive at a strategy decision and enable training. It may comprise a strategy decision module that leverages data analysis (e.g., natural language classification) to decide the strategy. This system may also comprise a strategy machine learning module, which is designed to learn from manual adjustments provided by a user, further refining the decision-making process and improving accuracy over time.

Technology learning and decision system 604 may be configured to arrive at a technology decision and enable training. This system may comprise a technology decision module that uses the input from data analysis (e.g., natural language classification) to make a decision about the technology component. Additionally, this system may comprise a technology machine learning module, which learns from manual adjustments provided by a user, thereby improving its ability to make accurate and informed decisions.

Deployment learning and decision system 606 may be configured to arrive at a deployment decision and enable training. It may comprise a deployment decision module that uses data analysis (e.g., natural language classification) to decide the deployment component. Like its counterparts, this system may also include a deployment machine learning module that is configured to learn from manual adjustments provided by a user, contributing to the ongoing improvement and accuracy of its decisions.

Technology strategic potential learning and decision system 608 may be configured to arrive at a technology strategic potential value and enable training. In some embodiments, it may include a technology strategic potential decision module configured to arrive at a comparative strategic potential score and associated costs of a technology against a given strategic component, considering factors such as industry, line of business, business functions, and application layer. Moreover, it may comprise a technology strategic potential machine learning module, which learns from manual adjustments received from a user, improving its decision-making process.

Deployment strategic potential learning and decision system 610 may be configured to arrive at a deployment strategic potential value and enable training. It might comprise a deployment strategic potential decision module that decides whether there are any changes with the comparative strategic potential score and related costs of a deployment against a given component, considering aspects like industry, line of business, business functions, and application layer. This system may also include a deployment strategic potential machine learning module that is configured to learn from manual fine-tuning received from a user, thus continually refining its accuracy and decision-making capability.

Existing workload strategy change learning and decision system 612 may be configured to decide whether there are any changes with the associated strategy of an existing workload and enable training. It may include an existing workload strategy change decision module configured to identify any changes. In addition to this, it may comprise an existing workload strategy change machine learning module that learns from manual adjustments provided from a user, ensuring continuous improvement and increasing accuracy in its decision-making process.

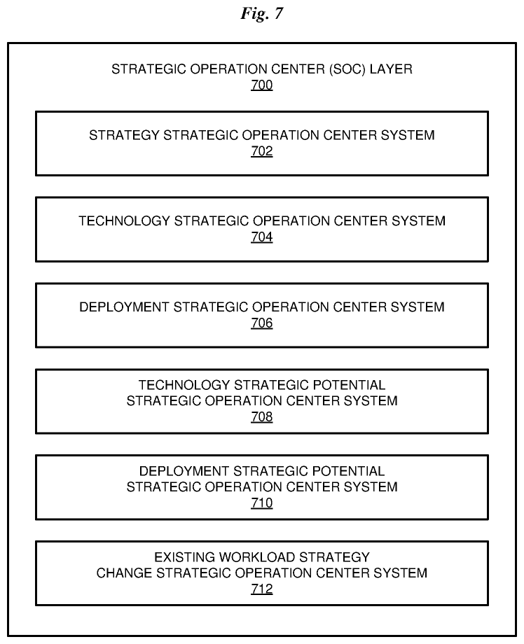

With reference to FIG. 7, this figure depicts a block diagram of an example strategic operation center layer 700, which various illustrative embodiments may implement. It is to be understood that the strategic operation center layer 700 may be implemented as a single unit or as a part of a larger system in which computer-usable program code or instructions implementing the processes may be located for the illustrative embodiments.

As shown, strategic operation center layer 700 may comprise a strategy strategic operation center system 702, a technology strategic operation center system 704, a deployment strategic operation center system 706, a technology strategic potential strategic operation center system 708, a deployment strategic potential strategic operation center system 710, and an existing workload strategy change strategic operation center system 712.

Strategy strategic operation center system 702 may enable fine-tuning of a strategy decision through user input. This may involve receiving manual confirmations or modifications to the output from the strategy decision module or manual additions of new strategies. This may enable the system to adapt to real-world feedback and incorporate human insights into the decision-making process. This system also maintains a record of strategies, categorized by factors such as industry, line of business, or application business functions, thereby creating a useful knowledge base for future decision-making.

Technology strategic operation center system 704 may enable fine-tuning of a technology decision through user input. It can receive manual confirmations or modifications to the decision output from the technology decision module, and it may also allow for manual additions of new technology components. This dynamic interaction enhances the system's decision-making capability and responsiveness to evolving technologies. Furthermore, it may store technology components and their related strategies, providing a comprehensive understanding of the technology-strategy relationship.

Deployment strategic operation center system 706 may enable fine-tuning of a deployment decision through user input. This may include manual confirmations or modifications to the output of the deployment decision module or manual additions of new deployments. This flexibility may enable the system to stay current with evolving deployment strategies. It may also store deployment components and related strategies, creating a robust and informative database for the development of future deployment strategies.

Technology strategic potential strategic operation center system 708 may enable fine-tuning of a technology strategic potential strategic operation decision through user input. This could involve receiving manual confirmations or modifications to the comparative strategic potential score and the related cost for a particular technology against a strategy. This may allow the system to continually adapt to real-world feedback and maintain the most relevant and efficient technology strategies.

Deployment strategic potential strategic operation center system 710 may enable fine-tuning of a strategy decision through user input. This may include receiving manual confirmations or modifications to the comparative strategic potential score and related cost for a particular deployment against a strategy. This system's ability to incorporate direct user feedback into its decision-making process may allow for a dynamic, responsive approach to determining deployment strategies.

Existing workload strategy change strategic operation center system 712 may enable fine-tuning of a suggested change in existing workload strategy through user input. This can involve receiving manual confirmations or modifications to a suggested change in an existing workload strategy. This process may ensure that the system stays current and aligned with the user's changing requirements and preferences, enabling it to deliver the most suitable strategies for each workload.

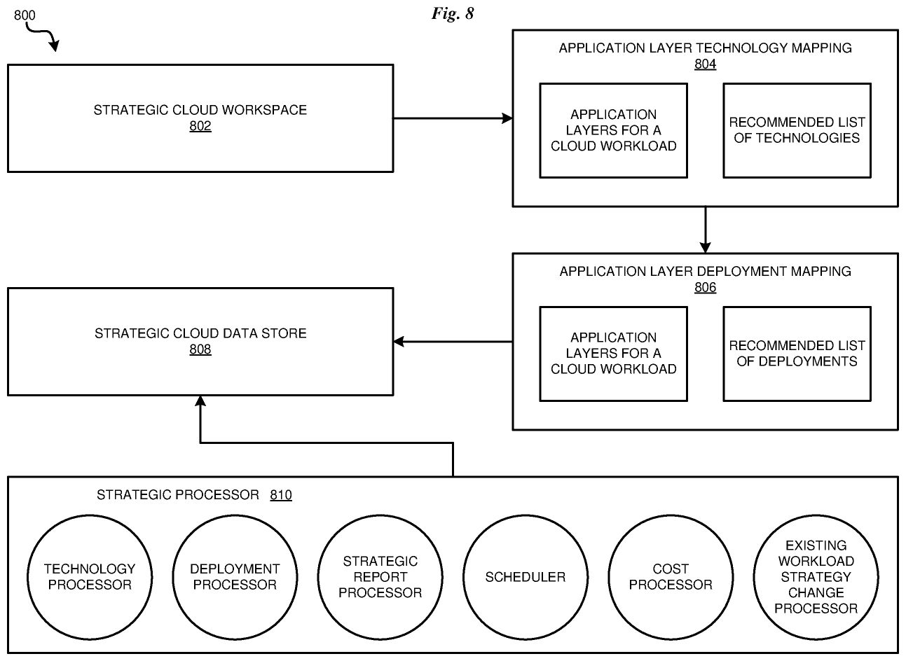

With reference to FIG. 8, this figure depicts a block diagram of an example strategic cloud layer 800, which various illustrative embodiments may implement. It is to be understood that the strategic cloud layer 800 may be implemented as a single unit or as a part of a larger system in which computer-usable program code or instructions implementing the processes may be located for the illustrative embodiments.

As shown, strategic cloud layer 800 may comprise strategic cloud workspace 802, application layer technology mapping 804, application layer deployment mapping 806, strategic cloud data store 808, and strategic processor 810.

Strategic cloud workspace 802 may be configured to map a workload to a strategy. This process may involve the utilization of a workload list and a strategy list. By doing so, the system can effectively associate the appropriate strategy with each workload, thereby enabling better strategic alignment and efficiency.

Application layer technology mapping 804 may be configured to select a technology best suited for a strategy. To achieve this, it may use a list of each application layer for a given workload and also employ a recommended list of technologies. These technologies may have higher strategic potential for the application layer in relation to a specific strategy. This mapping process may ensure the optimal alignment of technology and strategy for each layer of an application.

Application layer deployment mapping 806 may be configured to select a deployment that best fits a strategy. It may utilize a list of each application layer for a given workload and a recommended list of deployments. These patterns may have a higher strategic potential for the application layer against a specific strategy, thereby ensuring that the most suitable deployments are selected.

Strategic cloud data store 808 may serve as a repository for data related to strategic decisions. It may store strategic decision-related information, including strategies, workloads, application layers, technology mapping, and deployment mapping, among other data. This centralized storage of strategic information may allow for comprehensive analysis and decision-making.

Strategic processor 810 may comprise one or more processors for performing continuous strategic alignment. For instance, it may include a technology processor, which may check the workloads for each of the strategies and scans the technology strategic potential system for technologies with higher strategic potential for each of their application layers. Another strategic processor may be a deployment processor. Similar to the technology processor, the deployment processor may check the workloads for each of the strategies and scan the deployment strategic potential system for deployments with higher strategic potential for each application layer. Another strategic processor may be a strategic report processor, which may periodically scan through the strategic cloud data store and generate strategic reports, providing insights into the performance and effectiveness of strategic decisions. Another strategic processor may be a scheduler, which may be configured to periodically run technology analysis, deployment analysis, and other aforementioned analyses, and generate strategic alerts and reports. Another strategic processor may be a cost processor, which may be configured to consider cost factors for technology and deployment recommendations, and offer the best possible choices for the lowest possible cost. Lastly, another strategic processor may be an existing workload strategy change processor, which may be configured to check periodically for any changes in the strategy for existing workloads by querying the existing workload strategy change system. This may ensure that the system stays updated with any strategic shifts and adapts accordingly.

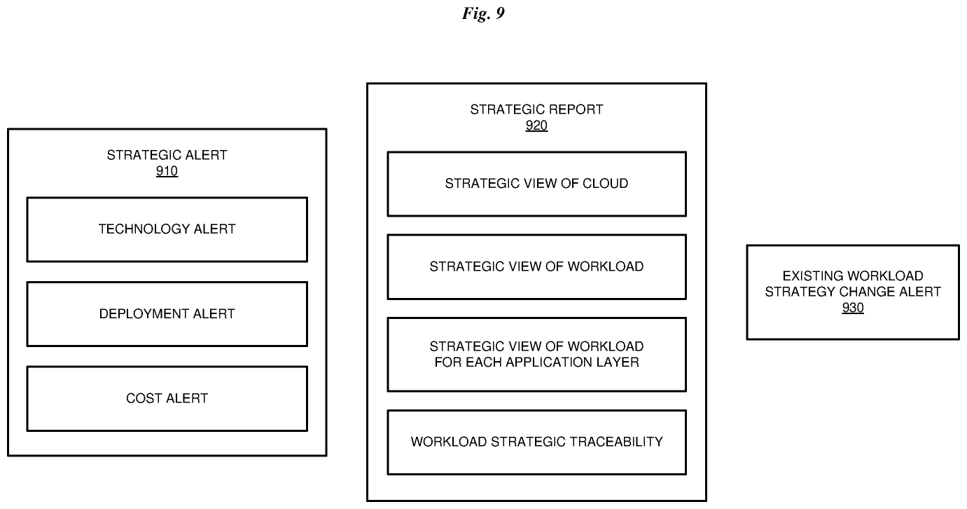

With reference to FIG. 9, this figure depicts a block diagram of example strategic alerts and recommendations, such as strategic alert 910, strategic report 920, and existing workload strategy change alert 930, which various illustrative embodiments may implement.

As illustrated, strategic alert 910 may comprise several alert types. This includes a technology alert, a deployment alert, and a cost alert. These alerts may be part of the strategic cloud workspace, which may serve as a cloud console view for the organization. This console may help in creating and managing strategic workloads on the cloud in accordance with the strategic components. In some embodiments, the technology alert may be triggered by the technology processor, which may scan the technology strategic potential system for technologies with higher technology strategic potential. If there is any target technology or combination with a higher technology strategic potential and equal or lower cost, a technology alert and/or cost alert may be transmitted to relevant stakeholders. Similarly, in some embodiments, the deployment alert may be triggered by the deployment processor, which may follow a similar process as the technology processor, but instead, it may scan the deployment strategic potential system for technologies with higher deployment strategic potential. If there is any deployment or combination with a higher deployment strategic potential and equal or lower cost, a deployment alert and/or cost alert may be transmitted to relevant stakeholders.

As further shown, strategic report 920 may comprise a strategic overview of the cloud environment, strategic cloud view of the workloads, a strategic cloud view of workloads for each application layer, and a workload strategic traceability report. The strategic report may also form part of the strategic cloud workspace in the cloud console view. The strategic cloud view of the workload may represent how the workload supports one or more organizational strategies for each of the application layers. It may, for example, display a percentage of strategic alignment of the cloud workloads. The strategy view of the cloud may provide stakeholders with a summary of detailed information on how various workloads are mapped against driving strategies. The workload strategic traceability may show how any workload's design or implementation is impacted based on strategic need, starting from the initial design to any strategic changes resulting from periodic strategic analysis, both for technology profile or for deployment profile related changes.

Existing workload strategy change alert 930 may comprise an alert mechanism that is triggered when there are changes in the strategy for existing workloads. This alert may allow the organization to track any strategic shifts in the existing workload and adapt accordingly. Specific elements of this alert might include changes in associated technology, deployments, or cost factors, each with potential implications for the strategy's realization. This alert may provide a constant update and enables a prompt response to any strategic changes, ensuring that the existing workload strategies remain aligned with the overall organizational strategies.

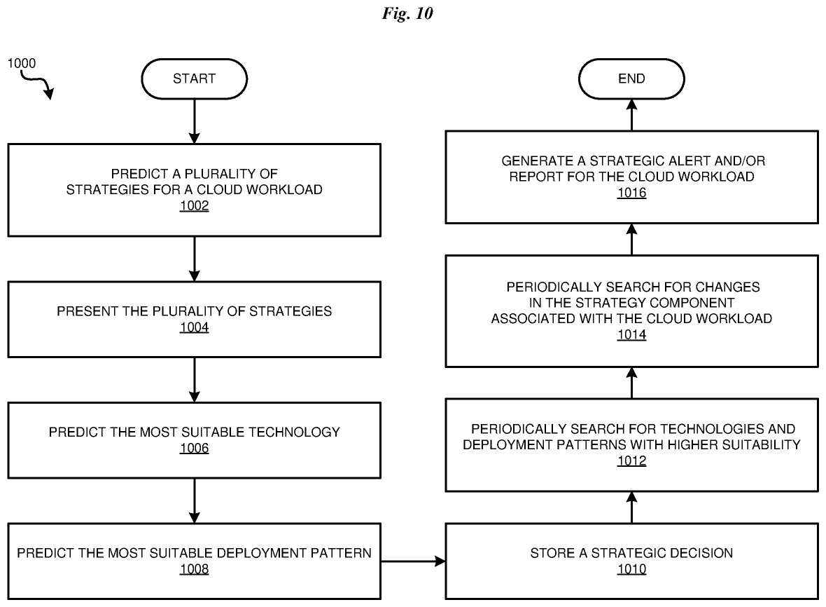

With reference to FIG. 10, this figure depicts a block diagram of an example process for strategic cloud management in accordance with an illustrative embodiment 1000. The example block diagram of FIG. 10 may be implemented using strategic cloud manager 200 of FIG. 1.

In the illustrative embodiment, at block 1002, the process predicts a plurality of strategies for a cloud workload. This step may involve using a workload strategy predictor, and it may involve gathering details of the workload, such as its name, key functionalities, and using an artificial intelligence-based predictor to determine the relevant strategies. For example, if an international flavor manufacturer is planning to develop and host a new cloud workload known as “Flavor Editor” for developing chemical formulas of various flavors, the workload strategy predictor could be called upon to identify the relevant strategies, such as differentiation, merger and acquisition, and low license cost. These strategies could be identified by analyzing structured and unstructured organization-related information present in a learning model and corpus.

At block 1004, the process presents the plurality of strategies. This step may involve presenting the predicted strategies to a strategic cloud user, such as a product owner, who then selects none, one, some, or all of these strategic components for alignment with the workload. It may also involve mapping each cloud workload against one or more strategies based on the selection. For example, once the strategies of differentiation, merger and acquisition, and low license cost are identified for Flavor Editor, these are presented to the strategic cloud user. They can then decide which of these strategies to adopt for the Flavor Editor workload.

At block 1006, the process predicts the most suitable technologies, such as the top five technologies based on cost and capability to fulfil the defined strategies. This step may involve invoking a strategic technology predictor to provide a list of technologies for each application layer, along with their strategic capability score and comparative license cost. For example, for the backend services of the Flavor Editor workload, the Spring Boot technology might be predicted to have the highest strategic capability score. It includes several artificial intelligence libraries like Deep Java Library to aid differentiation, exposes and consumes services from partner companies to assist in merger and acquisition, and has a zero license cost for development.

At block 1008, the process predicts the most suitable deployments, such as the top five deployments based on cost and capability to fulfil the defined strategies. This step may involve using a strategic deployment predictor, and it may involve leveraging the strategic deployment Predictor to identify various deployments, such as containers, PaaS applications, VMs, etc. For example, among various deployments, the PaaS deployment might be recommended with the highest score for the Flavor Editor workload. It supports easy availability, required scalability, and is less costly compared to containers.

At block 1010, the process stores a strategic decision, such as the workload, strategy, technology, or deployment for each of the application or architectural layer of the workloads. In one embodiment, the process stores the workload-strategy-technology-deployment combination. For instance, following the example above, this step may involve recording the selected combination, such as “Backend-Low License Cost-Spring Boot-PaaS,” by the strategic cloud module and notifying the stakeholders.

At block 1012, the process periodically searches for technologies and deployments with higher suitability, such as based on cost and capability. This step may involve periodically invoking the strategic technology predictor to check for any more suitable technology and/or invoking the strategic deployment predictor to check for any more suitable deployment. It may also involve notifying stakeholders. For example, the system may identify that a better technology than Spring Boot is available for Flavor Editor based on cost and capability, and it notify stakeholders of this better suited technology.

At block 1014, the process periodically searches for changes in the strategy associated with the cloud workload. This step may involve invoking the workload strategy predictor to learn if the organization has adopted a new strategy. It may also involve notifying stakeholders. For instance, following the example above, there may be a change in geography for Flavor Editor, which may increase the number of concurrent users of Flavor Editor, necessitating a change in the backend services.

At block 1016, the process generates a strategic alert and/or report for the cloud workload. This step may involve creating and distributing alerts and/or reports to stakeholders when changes in technology, deployments, or strategies are identified. For instance, if it becomes apparent that the PaaS deployment of Flavor Editor needs to be changed to containers due to a new strategic need, an alert is sent out to notify all stakeholders. This continuous monitoring and updating of strategies enable continuous strategic alignment cloud workloads.

It is to be understood that steps may be skipped, modified, or repeated in the illustrative embodiment. Moreover, the order of the blocks shown is not intended to require the blocks to be performed in the order shown, or any particular order.

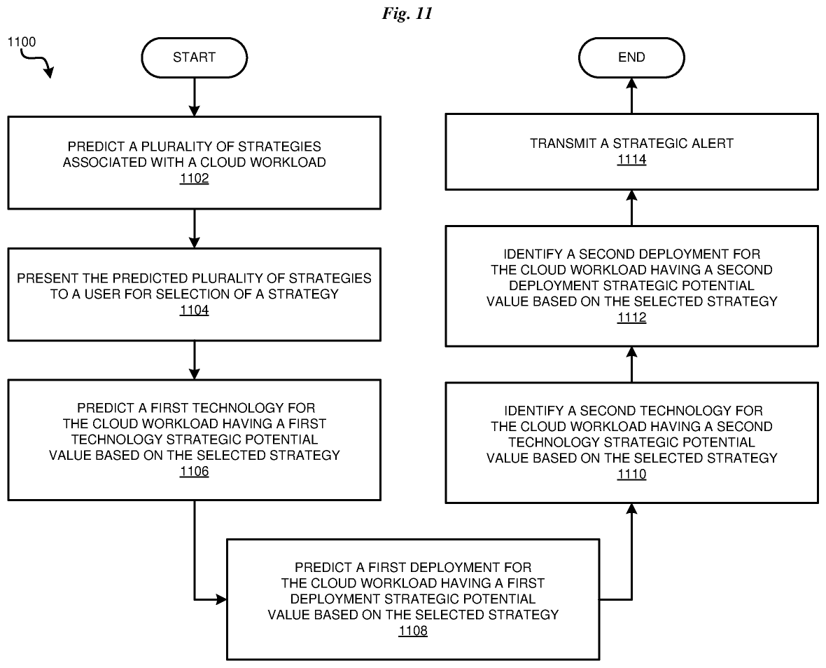

With reference to FIG. 11, this figure depicts a block diagram of an example process for strategic cloud management in accordance with an illustrative embodiment 1100. The example block diagram of FIG. 11 may be implemented using strategic cloud manager 200 of FIG. 1.

As illustrated, at block 1102, the process may predict a plurality of strategies associated with a cloud workload. At block 1104, the process may present the predicted plurality of strategies to a user for selection of a strategy. At block 1106, the process may predict a first technology for the cloud workload having a first technology strategic potential value based on the selected strategy. At block 1108, the process may predict a first deployment for the cloud workload having a first deployment strategic potential value based on the selected strategy. At block 1110, the process may identify a second technology for the cloud workload having a second technology strategic potential value based on the selected strategy, the second technology strategic potential value of the second technology indicating a greater technology strategic potential than the first technology strategic potential value of the first technology. At block 1112, the process may identify a second deployment for the cloud workload having a second deployment strategic potential value based on the selected strategy, the second deployment strategic potential value of the second deployment indicating a greater deployment strategic potential than the first deployment strategic potential value of the first deployment. At block 1114, the process may transmit a strategic alert. It is to be understood that steps may be skipped, modified, or repeated in the illustrative embodiment. Moreover, the order of the blocks shown is not intended to require the blocks to be performed in the order shown, or any particular order.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
predicting, using a workload strategy predictor, a plurality of strategies associated with a cloud workload;
presenting the predicted plurality of strategies to a user for selection of a strategy;
predicting, using a strategic technology predictor, a first technology for the cloud workload having a first technology strategic potential value based on the selected strategy;
predicting, using a strategic deployment predictor, a first deployment for the cloud workload having a first deployment strategic potential value based on the selected strategy;
executing the strategic technology predictor to identify a second technology for the cloud workload having a second technology strategic potential value based on the selected strategy, the second technology strategic potential value of the second technology indicating a greater technology strategic potential than the first technology strategic potential value of the first technology;
executing the strategic deployment predictor to identify a second deployment for the cloud workload having a second deployment strategic potential value based on the selected strategy, the second deployment strategic potential value of the second deployment indicating a greater deployment strategic potential than the first deployment strategic potential value of the first deployment; and
transmitting, responsive to the executing the strategic technology predictor and the executing the strategic deployment predictor, a strategic alert.

2. The method of claim 1, wherein the strategic technology predictor comprises a machine learning model configured to identify a plurality of technologies based on the cloud workload and the selected strategy.

3. The method of claim 1, wherein the strategic deployment predictor comprises a machine learning model configured to identify a plurality of deployments based on the cloud workload and the selected strategy.

4. The method of claim 1, further comprising:
generating a strategic report depicting an overview of the cloud workload, the selected strategy, the first technology, and the first deployment.

5. The method of claim 1, wherein the strategic alert includes one of an application notification, an email message, and a mobile phone message.

6. The method of claim 1, further comprising:
storing a strategic decision comprising the cloud workload, the selected strategy, the first technology, and the first deployment.

7. The method of claim 1, wherein a technology strategic potential value is based at least in part on technology capability and technology cost.

8. The method of claim 1, wherein a deployment strategic potential value is based at least in part on deployment capability and deployment cost.

9. The method of claim 1, wherein the executing the strategic technology predictor and executing the strategic deployment predictor is performed on a pre-determined schedule.

10. The method of claim 1, further comprising:
presenting a strategic cloud view including a percentage of cloud workloads in alignment with the selected strategy.

11. A computer program product comprising one or more computer readable storage media, and program instructions collectively stored on the one or more computer readable storage media, the program instructions executable by a processor to cause the processor to perform operations comprising:
predicting, using a workload strategy predictor, a plurality of strategies associated with a cloud workload;
presenting the predicted plurality of strategies to a user for selection of a strategy;
predicting, using a strategic technology predictor, a first technology for the cloud workload having a first technology strategic potential value based on the selected strategy;
predicting, using a strategic deployment predictor, a first deployment for the cloud workload having a first deployment strategic potential value based on the selected strategy;
executing the strategic technology predictor to identify a second technology for the cloud workload having a second technology strategic potential value based on the selected strategy, the second technology strategic potential value of the second technology indicating a greater technology strategic potential than the first technology strategic potential value of the first technology;
executing the strategic deployment predictor to identify a second deployment for the cloud workload having a second deployment strategic potential value based on the selected strategy, the second deployment strategic potential value of the second deployment indicating a greater deployment strategic potential than the first deployment strategic potential value of the first deployment; and
transmitting, responsive to the executing the strategic technology predictor and the executing the strategic deployment predictor, a strategic alert.

12. The computer program product of claim 11, wherein the strategic technology predictor comprises a machine learning model configured to identify a plurality of technologies based on the cloud workload and the selected strategy.

13. The computer program product of claim 11, wherein the strategic deployment predictor comprises a machine learning model configured to identify a plurality of deployments based on the cloud workload and the selected strategy.

14. The computer program product of claim 11, wherein a technology strategic potential value is based at least in part on technology capability and technology cost.

15. The computer program product of claim 11, wherein a deployment strategic potential value is based at least in part on deployment capability and deployment cost.

16. A computer system comprising a processor and one or more computer readable storage media, and program instructions collectively stored on the one or more computer readable storage media, the program instructions executable by the processor to cause the processor to perform operations comprising:
predicting, using a workload strategy predictor, a plurality of strategies associated with a cloud workload;
presenting the predicted plurality of strategies to a user for selection of a strategy;
predicting, using a strategic technology predictor, a first technology for the cloud workload having a first technology strategic potential value based on the selected strategy;
predicting, using a strategic deployment predictor, a first deployment for the cloud workload having a first deployment strategic potential value based on the selected strategy;
executing the strategic technology predictor to identify a second technology for the cloud workload having a second technology strategic potential value based on the selected strategy, the second technology strategic potential value of the second technology indicating a greater technology strategic potential than the first technology strategic potential value of the first technology;
executing the strategic deployment predictor to identify a second deployment for the cloud workload having a second deployment strategic potential value based on the selected strategy, the second deployment strategic potential value of the second deployment indicating a greater deployment strategic potential than the first deployment strategic potential value of the first deployment; and
transmitting, responsive to the executing the strategic technology predictor and the executing the strategic deployment predictor, a strategic alert.

17. The computer system of claim 16, wherein the strategic technology predictor comprises a machine learning model configured to identify a plurality of technologies based on the cloud workload and the selected strategy.

18. The computer system of claim 16, wherein the strategic deployment predictor comprises a machine learning model configured to identify a plurality of deployments based on the cloud workload and the selected strategy.

19. The computer system of claim 16, wherein a technology strategic potential value is based at least in part on technology capability and technology cost.

20. The computer system of claim 16, wherein a deployment strategic potential value is based at least in part on deployment capability and deployment cost.
